(19) United States
(12) Patent Application Publication
(10) Pub. No.: US 2003/0223367 A1
(43) Pub. Date: Dec. 4, 2003

(54) Methods for identifying network traffic flows

(76) Inventors: A. David Shay, Lawrenceville, GA (US); Michael S. Percy, Marietta, GA (US); Jeffry G. Jones, Canton, GA (US)

Correspondence Address: Malvern U. Griffin III, SUTHERLAND ASBILL & BRENNAN LLP, 999 Peachtree Street, NE, Atlanta, GA, 30309-3996, US

(21) Appl. No.: 10/403,956

(22) Filed: Mar. 31, 2003

Related U.S. Application Data
(60) Provisional application No. 60/369,101, filed on Mar. 29, 2002.

(51) Int. Cl. H04L 1/00

(52) U.S. Cl. 370/231; 370/395.32

(57) ABSTRACT

The present invention provides methods for identifying and tracking data packets across a network. Specifically, network monitoring devices are configured to identify particular data packets or traffic flows at different points in a network by conversation fingerprinting. Conversation fingerprinting involves creating a unique identifier based on an invariant portion of one or more data packets in a traffic flow. An equivalency test is then performed between two identifiers from different monitoring devices to determine if the same data packet is received at two or more network monitoring devices. In order to reduce the probability of mismatches, additional heuristics may be applied based on additional attributes of the data packet or conversation. If a match occurs, then the timestamps of the two identifiers are compared to determine the point-to-point network transit latency between the two network monitoring devices.

### CROSS-REFERENCE TO RELATED APPLICATIONS

This application claims benefit of co-pending U.S. Provisional Application No. 60/369,101, filed Mar. 29, 2002, which is entirely incorporated herein by reference. In addition, this application is related to the following co-pending, commonly assigned U.S. applications, each of which is entirely incorporated herein by reference: “Systems and Methods for End-to-End Quality of Service Measurements In A Distributed Network Environment” filed Mar. 31, 2003, and accorded Publication No. ______; and “Forward Looking Infrastructure Re-Provisioning” filed Mar. 31, 2003, and accorded Publication No.______.

### TECHNICAL FIELD

The field of the present invention relates generally to systems and methods for providing end-to-end quality of service measurements in a distributed network environment. More particularly, the present invention relates to systems and methods for identifying and tracking network data packets across a distributed network despite the masking effects of network address translations and other modifications.

### BACKGROUND OF THE INVENTION

In order to produce metrics needed for quality-of-service analyses and usage-based accounting, it is important to be able to identify and track particular data packets or groups of data packets at different points in the network. Tracking data packets and/or network traffic flows across a network, in the abstract, is a simple concept. Network monitoring devices (e.g., flow meters) may be used to record streams of network packets and to classify the data packets into traffic flows (also referred to as conversations), summarize attributes of the traffic flows, and store the results for subsequent reporting. Two or more network monitoring devices may be employed to compare attributes of particular data packets or conversations at different points in the network.

In practice, however, tracking data packets and/or network traffic flows across a network can be a complicated task. In particular, network devices, such as routers, firewalls, etc., can modify each data packet as it passes through the network device. Such modifications can prevent the use of simple equivalence tests to identify the same data packets or conversations at different network points. As an example, network address translation (“NAT”) is performed by routers and firewalls to map a private network address into a public network address. Multiple network address translations may be applied to each data packet as it transits the network. Furthermore, it is generally impossible to know how many network address translations and/or other modifications have been applied to a data packet before it is observed by a network monitoring device.

As an example, in order to measure a metric known as latency, it is critical to be able to identify a particular packet at different points in the network. A common method of estimating latency, in view of network address translations, is to inject test packets into the data stream that can clearly be identified at each network point. Test packets may be identified by causing them to include an artificial pattern or other identifier that is unlikely to occur normally in the network. However, such test packets might not exhibit actual latencies if there are quality-of-service differences in the network for different types of traffic. In addition, adding test packets to the data stream increases network congestion. Thus, a more accurate measurement of latency would be based on actual application packets measured in situ.

Accordingly, there remains a need for a system and method for identifying and tracking particular data packets across a network despite the masking effects of network address translations and other modifications.

### SUMMARY OF THE INVENTION

The present invention provides methods for identifying and tracking data packets across a network. Specifically, network monitoring devices are configured to identify particular data packets or traffic flows at different points in a network by conversation fingerprinting. Conversation fingerprinting involves creating a unique identifier based on an invariant portion of one or more data packets in a traffic flow. An equivalency test is then performed between two identifiers from different monitoring devices to determine if the same data packet is received at two or more network monitoring devices. In order to reduce the probability of mismatches, additional heuristics may be applied based on additional attributes of the data packet or conversation. If a match occurs, then the timestamps of the two identifiers are compared to determine the point-to-point network transit latency between the two network monitoring devices.

In accordance with an aspect of the present invention, a method for system for identifying network traffic flows in order to provide end-to-end quality of service measurements in a distributed network environment comprises receiving a first observed data packet and applying a first timestamp thereto, identifying an invariant portion of the first observed data packet, applying a hash function to the invariant portion of the first observed data packet to produce a first hash key, comparing the first hash key to a second hash key produced by applying the hash function to another observed data packet, and if the first hash key matches the second hash key, comparing the first timestamp of the first observed data packet with a second time stamp of the second observed data packet in order to calculate network latency.

In accordance with another aspect of the present invention, a method for system for identifying network traffic flows in order to provide end-to-end quality of service measurements in a distributed network environment comprises applying a hash function to the first invariant combination to produce a first hash key, recording one or more additional attributes of the first conversation instance, associating the first hash key with the timestamps of selected data packets of the first conversation instance and the one or more additional attributes, comparing the first hash key to a second hash key produced by applying the hash function to a second invariant combination derived from a second conversation instance, if the first hash key matches the second hash key, comparing the one or more additional attributes of the first conversation instance with one more corresponding attributes associated with the second conversation instance, and if the one or more additional attributes match the one more corresponding attributes, comparing the timestamps associated with the first hash key to corresponding timestamps associated with the second hash key in order to calculate network latencies.

### BRIEF DESCRIPTION OF THE DRAWINGS

FIG. 1 is a high-level block diagram illustrating the components that make-up the framework of the present invention according to one or more exemplary embodiments thereof.

FIG. 2 is a flow chart illustrating an exemplary conversation fingerprinting method of the present invention.

FIG. 3 is a flow chart illustrating an exemplary method for determining network latency based on conversation fingerprints.

### DETAILED DESCRIPTION OF EXEMPLARY EMBODIMENTS

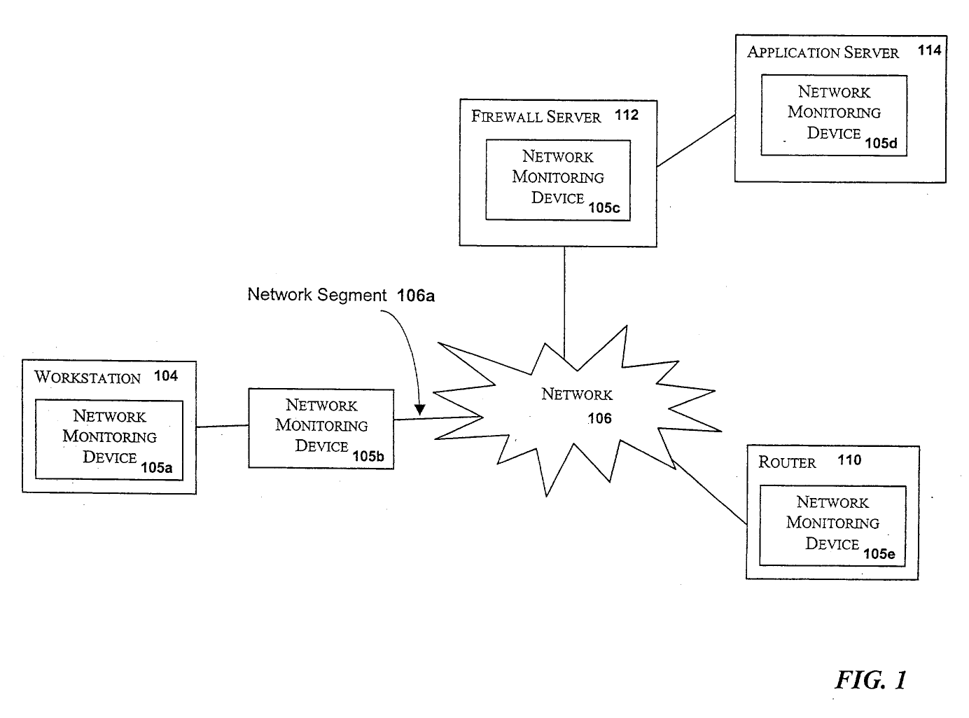

The present invention provides a system and method for identifying and tracking network data packets across a distributed network despite the masking effects of network address translations and other modifications. Exemplary embodiments of the present invention are described with reference to the figures, in which like numerals represent like elements. FIG. 1, represents a high-level block diagram of an exemplary operating environment for implementation of certain embodiment of the present invention. As depicted, an exemplary operating environment includes various network devices configured for accessing and reading associated computer-readable media having stored thereon data and/or computer-executable instructions for implementing various methods of the present invention. The network devices are interconnected via a distributed network 106 comprising one or more network segments. The network 106 may comprise any telecommunication and/or data network, whether public or private, such as a local area network, a wide area network, an intranet, an internet and any combination thereof and may be wire-line and/or wireless.

Generally, a network device includes a communication device for transmitting and receiving data and/or computer-exec executable instructions over the network 106, and a memory for storing data and/or computer-executable instructions. A network device may also include a processor for processing data and executing computer-executable instructions, as well as other internal and peripheral components that are well known in the art (e.g., input and output devices.) As used herein, the term “computer-readable medium” describes any form of computer memory or a propagated signal transmission medium. Propagated signals representing data and computer-executable instructions are transferred between network devices.

A network device may generally comprise any device that is capable of communicating with the resources of the network 106. A network device may comprise, for example, a server (e.g., firewall server 112 and application server 114), a workstation 104, a router 110, and other devices. The term “server” generally refers to a computer system that serves as a repository of data and programs shared by users in a network 106. The term may refer to both the hardware and software or just the software that performs the server service.

A workstation 104 may comprise a desktop computer, a laptop computer and the like. A workstation 104 may also be wireless and may comprise, for example, a personal digital assistant (PDA), a digital and/or cellular telephone or pager, a handheld computer, or any other mobile device. These and other types of workstations 104 will be apparent to one of ordinary skill in the art. Firewall servers 112 and routers 110 are well-known in the art and are therefore not described in further detail herein.

Network monitoring devices 105a-e (e.g., flow meters) may be installed on any network device or on any network segment 106a. The term network monitoring device 105a-e may refer to software and/or hardware components for recording streams of network packets, classifying the recorded data packets into traffic flows (also referred to as conversations), summarizing attributes of the traffic flows, and storing the results for subsequent reporting. In accordance with the present invention, network monitoring devices may be configured for implementing a process, referred to herein as “conversation fingerprinting,” for identifying particular data packets or traffic flows at different points on the network 106.

Conversation fingerprinting involves creating a unique identifier based on an invariant portion of one or more data packets in a traffic flow (also referred to as a conversation). The invariant portion of a data packet may be any portion that is not modified in transit due to network address translation or other modifications. Addresses and other fields in the header portion of a data packet are typically not invariant. The data payload of a data packet is typically invariant (before or after encryption).

By identifying the invariant portion of a data packet, it is possible to perform a simple equivalence test to determine if the same data packet is received at two or more network monitoring devices 105a-e. Note that the equivalence test determines a relative equivalence and not an absolute identify between data packets because two unique data packets may contain the same invariant. As an analogy, consider two identical decks of playing cards, “deck A” and “deck B,” that are shuffled together. A selected card may be identified as, for example, the two of hearts, thus distinguishing its relative functionality from that of the other cards. However, without more information, it is not possible to identify the selected card as being from deck A or from deck B.

Accordingly, in the case were two unique data packets contain the same invariant data, using a simple equivalence test to compare invariant data may actually result in a mismatch. In order to reduce the probability of mismatches, additional heuristics may be applied based on additional attributes of the data packets or conversations. Such additional attributes may include the number of bits or bytes of the packet or conversation and/or the number of packets in the conversation. Since it is not rare to see a sequence of identically formed conversations (having the same invariant data and attributes in every regard) occurring several minutes apart, one other component of the heuristic may be time-based. In particular, it can be assumed that two equivalent packets or conversation seen at two points in the network a few hundred milliseconds apart instances of the identical data packet or conversation. While another instance of the equivalent data packet or conversation observed several minutes later may be assumed to be a distinct packet or conversation.

Even when additional heuristics are applied, it is still statistically possible for mismatches to occur. As mentioned, two apparently equivalent conversations or data packets may actually be distinct conversations or data packets. In addition, because order-of-arrival cannot be guaranteed, it cannot be known with certainty whether two equivalent, yet distinct, conversations or data packets were received in the proper order, meaning that any latency measurements could be wrong. However, such mismatches and potential latency errors may be ignored as the rarity they are without loss of generality. In other words, an occasional missed measurement that otherwise is assumed to be drawn from the population at random does not hurt the statistical properties of the system.

The invariant data from two or more data packets must be transferred to a common location, such as a network monitoring device 105 or a controller 109 configured for performing equivalence tests and additional heuristics. This implies that to compare multiple instances of a particular data packet or conversation, each network monitoring device 105 must collect invariant data (and optionally other attributes) and transmit the collected data (and any attributes) to a common location. This increases network usage by a factor of n, where n is the number of network monitors. In order to minimize the impact on network, the essence of the invariant data may be distilled into a fixed number of bits that is substantially smaller than the number of bits in the original invariant data. The distilled data and any associated attributes may be transmitted by each network monitoring device 105 to a common location for comparison.

Distilling the essence of the invariant data may be achieved, for example, by applying a hashing function to the invariant data. The hashing function may be a cyclic redundancy check (“CRC”) or any other sort of checksum mechanism. The hashing function may be chosen such that two identical sets of invariant data produce an equivalent hash key, while two sets of invariant data that produce different hash keys are not identical. However, as described above, equivalent hash keys does not ensure matching of identical conversations or data packets because it is possible that different sets of invariant data might produce the same hash key. The probability of different sets of invariant data producing the same hash key is dependent on the particular hashing mechanism used. For example if all invariant data patterns are equally likely and CCITT-CRC32 (an international standard 32-bit CRC mechanism) is used, different patterns have different CRC values approximately 99.9999999767% of the time.

An important property of the hash key mechanism is that it is noninvertible. In other words, it is impossible to derive the input dataset from the hash key. Therefore, sending hash keys of data sets across a public network poses no security risk that the original data set can be reconstructed. Still, additional encryption techniques may be applied if desired.

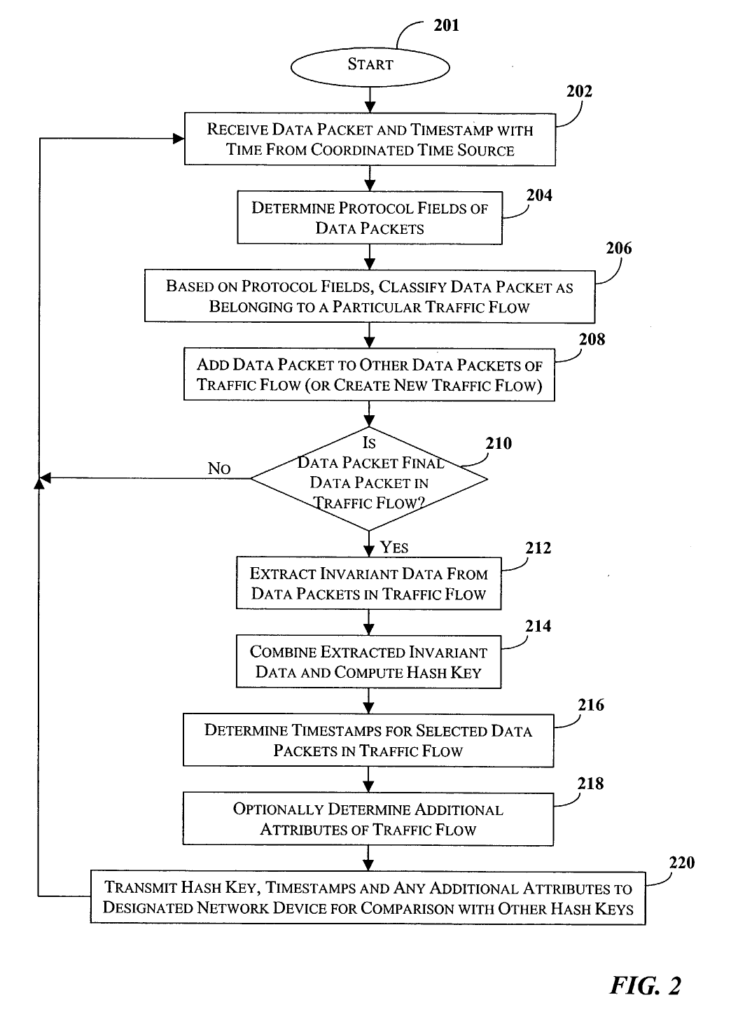

FIG. 2 is a flow chart illustrating an exemplary conversation fingerprinting method of the present invention. The method begins at start step 201 and advances to step 202, where a data packet is received and time-stamped with time information from a coordinated time source. At step 204, the packet protocol fields are determined, which might involve identifying multiple protocol layers (e.g., Ethernet header, IP header, TCP header). Using the protocol fields, the data packet may be classified as belonging to a particular traffic flow, such as a particular TCP stream, at step 206. Then at step 208, the classified data packet is added to any packets already identified as belonging to the traffic flow, or is considered to be the initial data packet in a new traffic flow.

At step 210, a determination is made as to whether the data packet is the final packet in a conversation. This determination may be made based on protocol rules, a timeout interval or other methods. The timeout interval may be specified by the network administrator or any other person or entity. If the data packet is not the final data packet in the traffic flow, the method returns to step 202 to receive the next data packet. When the final data packet in the traffic flow is ultimately received, the method advances to step 212, where the invariant data from each data packet in the traffic flow is extracted. Again, the invariant data may be identified based on protocol rules. At step 214, the extracted invariant data from each data packet is combined and a hash key is computed for the combination.

Next at step 216, time stamps are determined for selected data packets in the traffic flow. For example, the selected data packets may be the first and last data packets in each direction of the traffic flow (i.e., first and last packets received by a network device and first and last packets sent by the network device). The timestamps of the first and last data packets in each direction of a traffic flow are typically good indicators of latency. Other selected data packets may be chosen if desired.

At step 218 additional attributes of the traffic flow may be recorded. Again, such additional attributes may relate to the number of data packets, bytes or bits in the conversation. Other measurable attributes will occur to those of ordinary skill in the art and are therefore deemed to be contemplated by the present invention. At step 220 the hash key, the timestamps of the selected data packets and any additional attributes of the conversation are transmitted to a designated network device for comparison. Following step 220, the method returns to step 202 where another data packet is received and the method is repeated.

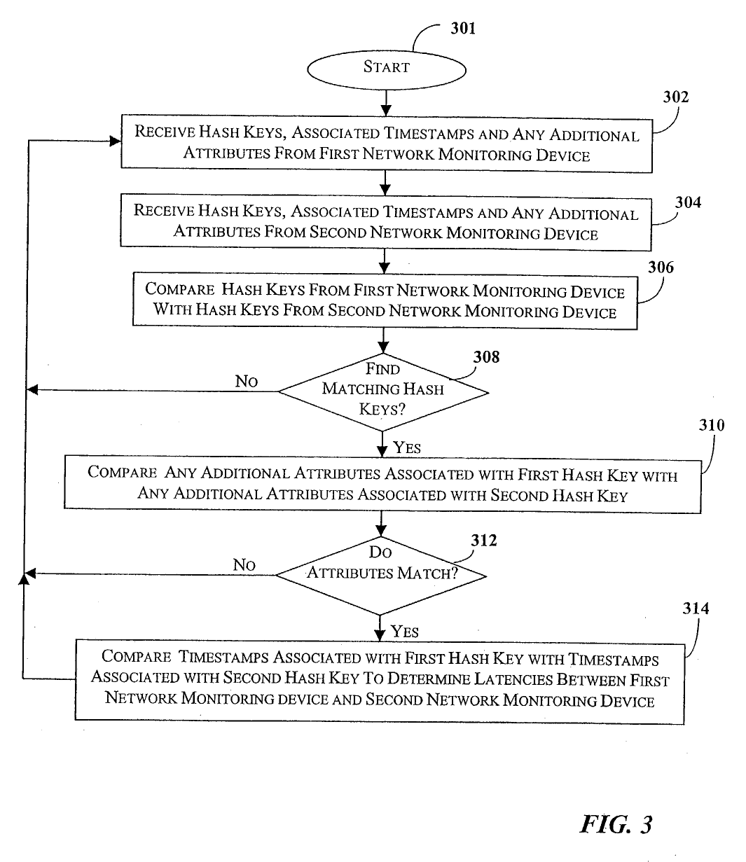

FIG. 3 is a flow chart illustrating an exemplary method for determining network latency based on conversation fingerprints. The exemplary method begins at step 301 and advances to step 302, where hash keys, associated timestamps and any additional attributes are received from a first network monitoring device. Similarly, at step 304 hash keys, associated timestamps and any additional attributes are received from a second network monitoring device. It should be noted that steps 302 and 304 are presented by way of illustration only and are not intended to reflect a fixed sequence. The order in which hash keys and associated data are received from different network monitoring devices may vary.

Next at step 306, the hash keys received from the first network monitoring device are compared to the hash keys received from the second network monitoring device. If it is determined at step 308 that no hash key received from the first network monitoring device matches a hash key received from the second network monitoring device, the method returns to and is repeated from step 302. However, if it is determined at step 308 that a hash key received from the first network monitoring device matches a hash key received from the second network monitoring device, the method proceeds to step 310, where any additional attributes associated with the first hash key are compared to corresponding attributes of the second hash key.

If it is then determined at step 312 that the attributes associated with the first hash key do not match the corresponding attributes of the second hash key, the first and second hash keys are considered to have been derived from distinct conversations and the method returns to and is repeated from step 302. However, if the attributes associated with the first hash key do match the corresponding attributes of the second hash key, the probability of the first and second hash keys having been derived from the same conversation is considered to be very high and the method moves to step 314. At step 314, the timestamps associated with the first hash key are compared to the corresponding timestamps associated with the second hash key in order to determine point-to-point network transit latencies between the first network monitoring device and the second network monitoring device. Following step 314, the method returns to and is repeated from step 302.

From a reading of the description above pertaining to various exemplary embodiments, many other modifications, features, embodiments and operating environments of the present invention will become evident to those of skill in the art. The features and aspects of the present invention have been described or depicted by way of example only and are therefore not intended to be interpreted as required or essential elements of the invention. It should be understood, therefore, that the foregoing relates only to certain exemplary embodiments of the invention, and that numerous changes and additions may be made thereto without departing from the spirit and scope of the invention as defined by any appended claims.

We claim:

1. A method for system for identifying network traffic flows in order to provide end-to-end quality of service measurements in a distributed network environment, the method comprising:
receiving a first observed data packet and applying a first timestamp thereto;
identifying an invariant portion of the first observed data packet;
applying a hash function to the invariant portion of the first observed data packet to produce a first hash key;
comparing the first hash key to a second hash key produced by applying the hash function to another observed data packet; and
if the first hash key matches the second hash key, comparing the first timestamp of the first observed data packet with a second time stamp of the second observed data packet in order to calculate network latency.

2. The method of claim 1, wherein the hash function is a cyclic redundancy check mechanism.

3. The method of claim 1, further including classifying the first observed data packet as belonging to a first traffic flow, wherein the other data packet also is classified as belonging to the first data traffic flow.

4. The method of claim 1, further including determining if the first observed data packet is a final data packet in a traffic flow or conversation.

5. The method of claim 1, further including receiving additional attributes associated with the first observed data packet.

6. The method of claim 5, further including comparing the additional attributes of the first observed data packet to additional attributes associated with the other data packet.

7. A method for system for identifying network traffic flows in order to provide end-to-end quality of service measurements in a distributed network environment, the method comprising:
applying a hash function to a first invariant combination of a first conversation instance to produce a first hash key;
recording one or more additional attributes associated with the first invariant of the first conversation instance;
associating the first hash key with the timestamps of selected data packets of the first conversation instance and the one or more additional attributes;
comparing the first hash key to a second hash key produced by applying the hash function to a second invariant combination from a second conversation instance;
if the first hash key matches the second hash key, comparing the one or more additional attributes of the first conversation instance with one more corresponding attributes associated with the second conversation instance; and
if the one or more additional attributes match the one more corresponding attributes, comparing the timestamps associated with the first hash key to corresponding timestamps associated with the second hash key in order to calculate network latencies.

8. The method of claim 7, wherein the hash function is a cyclic redundancy check mechanism.

9. The method of claim 7, wherein the additional attributes include at least one of the number of bytes of data in the conversation instance and number of packets in the conversation instance.

10. The method of claim 7, wherein the first conversation instance and the second conversation instance are received at two distinct network monitoring devices.
